(19) United States
(12) Patent Application Publication
(10) Pub. No.: US 2007/0022038 A1
(43) Pub. Date: Jan. 25, 2007

(54) System and method for batch bidding on employee stock options

(75) Inventors: David A. Seaman, Short Hills, NJ (US); Santosh V. Nabar, Englewood, NJ (US)

Correspondence Address: MILBANK, TWEED, HADLEY & MCCLOY, 1 CHASE MANHATTAN PLAZA, NEW YORK, NY, 10005-1413, US

(73) Assignee: JP Morgan Chase & Co.

(21) Appl. No.: 11/247,636

(22) Filed: Oct. 11, 2005

Related U.S. Application Data
(60) Provisional application No. 60/701,456, filed on Jul. 21, 2005.

(51) Int. Cl. G06Q 40/00

(52) U.S. Cl. 705/37

(57) ABSTRACT

A company issues options to an employee on stock of an issuing company at a first time. The options comprising at least a strike price, a maturity date and a vesting date. Information on the options is provided to a plurality of bidders at a second time that is after the first time. The information comprising strike price, maturity date and number of options. Bid information is received from the plurality of bidders. A probability distribution function is selected, and a price density distribution is computed for the plurality of bidders using the received bid information and the probability distribution function. A preferred bidder is selected from the plurality of bidders based on the price density distribution, and the bid information from the preferred bidder is provided to the employee.

This application claims priority to U.S. Provisional patent application Ser. No. 60/701,456, filed Jul. 21, 2005, entitled SYSTEM AND METHOD FOR BIDDING ON EMPLOYEE STOCK OPTIONS, the disclosure of which is incorporated herein by reference.

### BACKGROUND

The invention relates to the field of securities, and more particularly to the field of employee stock options.

Companies frequently issue employee stock options. However, these options generally include restrictions on sale or transfer, and the restrictions impact the option value. Systems and methods are needed to provide for sale or transfer of employee stock options, and systems and methods that allow employees to get the best price for their options.

The preceding description is not to be construed as an admission that any of the description is prior art relative to the present invention.

### SUMMARY OF THE INVENTION

The various aspects of the embodiments provide a system and method for bidding on employee stock options. The system and method comprise issuing options to an employee on stock of an issuing company at a first time, the options comprising at least a strike price, a maturity date and a vesting date. The system and method further comprise providing information on the options to a plurality of bidders at a second time that is after the first time, the information comprising strike price, maturity date and number of options. The system and method further comprise receiving bid information from the plurality of bidders, and selecting a probability distribution function. The system and method further comprise computing a price density distribution for the plurality of bidders using the received bid information and the probability distribution function. The system and method further comprise selecting a preferred bidder from the plurality of bidders based on the price density distribution. The system and method further comprise providing the bid information from the preferred bidder to the employee.

In another aspect, the system and method further comprise receiving an order from the employee to sell or transfer at least some of the options, executing at least part of the order, and providing order execution information to the employee. In one aspect, the order is a market order to sell. In one aspect, the order is a limit order to sell. In one aspect, the order comprises a number of options to sell. In another aspect, the system and method further comprise determining a stock price, and determining an execution price using at least the stock price and the bid information from the preferred bidder. In one aspect, determining a stock price, and determining an execution price occurs following the close of a predetermined election period. In one aspect, the bid information is bid price. In one aspect, the price density distribution is a sumproduct of price and probability. In one aspect, the preferred bidder is the preferred bidder for all options. In one aspect, the preferred bidder is the preferred bidder for options with a particular vesting date. In one aspect, the preferred bidder is the preferred bidder for options with a particular strike price. In one aspect, the preferred bidder is the preferred bidder for a particular stock price. In one aspect, receiving bid information from the plurality of bidders further comprises receiving an option price model from at least one bidder. In one aspect, receiving bid information from the plurality of bidders further comprises receiving a price grid from at least one bidder. In one aspect, the preferred bidder is a winning bidder. In one aspect, the probability distribution function is a normal distribution function. In one aspect, the normal distribution function includes an impulse to account for prices below zero. In one aspect, the probability distribution function is a lognormal distribution function. In one aspect, the probability distribution function is a chi-squared distribution function. In one aspect, providing information on the options to a plurality of bidders, receiving bid information from the plurality of bidders, computing a price density distribution for the plurality of bidders, selecting a preferred bidder from the plurality of bidders, and providing the bid information from the preferred bidder to the employee occurs during a predetermined election period. In one aspect, the price density distribution spans an integer number of standard deviations above and below a stock price. In one aspect, the integer number of standard deviations is one standard deviation above and below the stock price. In one aspect, the integer number of standard deviations is two standard deviations above and below the stock price.

The foregoing specific aspects are illustrative of those which can be achieved and are not intended to be exhaustive or limiting of the possible advantages that can be realized. Thus, the objects and advantages will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an example system according to an embodiment;

FIG. 2 illustrates steps in an example method according to an embodiment;

FIG. 3 illustrates valuation of an employee stock option without the invention; and

FIG. 4 illustrates various probability distribution functions.

It is understood that the drawings are for illustration only and are not limiting.

### DETAILED DESCRIPTION OF THE DRAWINGS

In the embodiments described below, a company issues employee stock options and then during an election period, provides information to bidders on employee stock options that are eligible for sale or transfer. The bidders provide bid prices on the options eligible for sale or transfer, and the bid prices from each bidder are weighted using a probability distribution function to identify a preferred or winning bidder for the options. During the election period, the employees are able to review the bid prices and place orders to sell or transfer their options. The election period closes and the preferred bidder is informed of the options that they will purchase or receive, with the price determined from a reference stock price, which is determined during a stock price averaging period. The employee orders to sell or transfer their options are then executed, and details of the execution are reported to the employee and winning bidder.

Companies grant employee stock options (ESOs) to employees and management. These ESOs are typically fixed strike call options with a set maturity that are issued by the employer or company, and are subject to vesting and other restrictions. One significant restriction is that ESOs may not be resold, transferred, pledged or hedged, which limits and reduces the value of the ESOs relative to a pure Black-Scholes or other option model value of an unrestricted option. Because ESOs are subject to vesting, are not freely tradable, and are held by less than perfectly diversified employees, employees tend to value them for less than the ESO might be economically worth to others. Further, employees may exercise their vested ESOs early because they cannot sell or transfer them. This early exercise behavior is not “optimal” from a risk-neutral option valuation perspective, but is rational as employees seek to optimize their less diversified/risk averse utility.

Although ESOs are valued by employees, they are probably valued by employee holders at less than their economic worth. Employees tend to value their options for what they would get for them by exercising them (i.e., their “intrinsic” value) and not the higher theoretical option value.

As stated above, ESOs are generally granted with vesting restrictions and prohibitions on transfer. Typically the issuing company board of directors controls transferability, and limited transferability is often allowed for estate purposes (gifting or transfer of ESO to a family trust or family member). However the ESOs are still subject to vesting restrictions, and lapse rules (or if lapse rules have been removed, then claw-back provisions against the employee if they leave within a specified time period). In a small number of circumstances, some companies may allow senior executives to transfer ESOs to a “exchange fund” partnership to diversify their ESO positions.

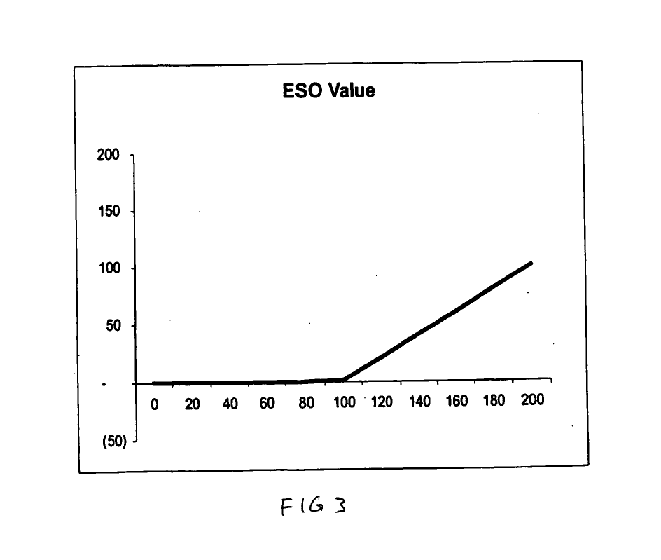

An option is “underwater” or “out-of-the-money” when the stock price is below the option exercise or strike price, and ESOs tend to lose their incentive or motivational impact when they are underwater. The loss in incentive results from the fact that employees can only exercise (not sell or transfer) their options, and thus when the option is underwater, it has limited or no value to the employee. In fact, deep underwater options can be demotivating, because the likelihood of payout is quite low. Referring to FIG. 3, the value of an ESO with a strike price of $100 is illustrated with the stock price of the underlying stock on the horizontal axis. When the stock price is less than the strike price of $100, the option is underwater, and has no value if exercised.

To address these problems, companies have attempted to manage their underwater ESO exposure by: 1) restriking down the option exercise price; 2) canceling awards and awarding new grants; 3) accelerating new grants; and 4) tendering for the underwater options (for cash or stock). However, these one-time fixes can create adverse stockholder reaction.

There are a number of reasons why companies have not granted broadly transferable ESOs, and one reason is that the U.S. tax code seems to suggest that granting transferable stock options is taxable upon grant. Section 83 of the U.S. tax code states that options that have “readily ascertainable fair market value” are taxable upon grant. In contrast, current tax treatment of non-transferable ESOs suggests that the grant is non-taxable and only the exercise or sale of the ESO is a taxable event. For a number of reasons, most employers and employees don't want to have the grant of the ESO to be a taxable event.

Options and warrants are different, and companies grant warrants to investors, business partners, and lenders, which are generally transferable under applicable SEC exemptions (registration, private placement, etc.). These warrants are exercisable under their terms and generally do not lapse. These warrants are sold for cash or issued as part of an exchange for goods or services.

Fully transferable stock options can be priced using an option pricing model and risk-neutral pricing theory. The lack of transferability and required lapse upon termination of employment motivate employees to exercise their ESOs early, which is also suboptimal from a theoretical risk neutral valuation perspective.

Recently, some methods have been disclosed that allow an employee to sell or transfer their ESOs. One such method is described in U.S. Published Patent Application 2004/0267656 A1. However, even where ESOs can be transferred or traded, there may be limited opportunities for the transfer, and the employee may not have any real assurance that they are getting the best price for their ESOs. There are few if any programs or methods to allow multiple bidders one the ESOs, where the employee sells to the highest bidder.

An Example System

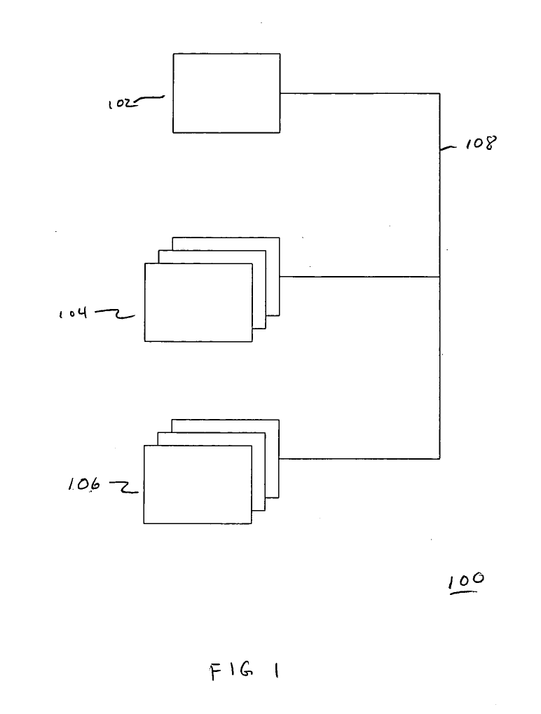

Referring to FIG. 1, an example system 100 according to one embodiment includes a company 102 that issues options on company stock to employees 104. System 100 also includes a market 106 where third-party purchasers or bidders can purchase the ESOs. Although not illustrated, company 102, employees 104 and market 106 include computers with central processor units (CPUs), volatile and non-volatile memory (RAM, ROM, EPROM, flash, etc.), fixed and removable code storage devices (floppy drives, hard drives, memory sticks, tape, CD, DVD, etc.), input/output devices (keyboards, display monitors, printers, pointing devices, etc.), and network interface devices (Ethernet cards, WiFi cards, modems, etc.). Company 102, employees 104 and market 106 are interconnected by network 108, which may be a LAN, WAN, intranet, extranet, the Internet, the PSTN, etc. Computer executable software code is stored on the fixed and removable code storage devices, and is also transferred as an information signal, such as by download.

An Example Method

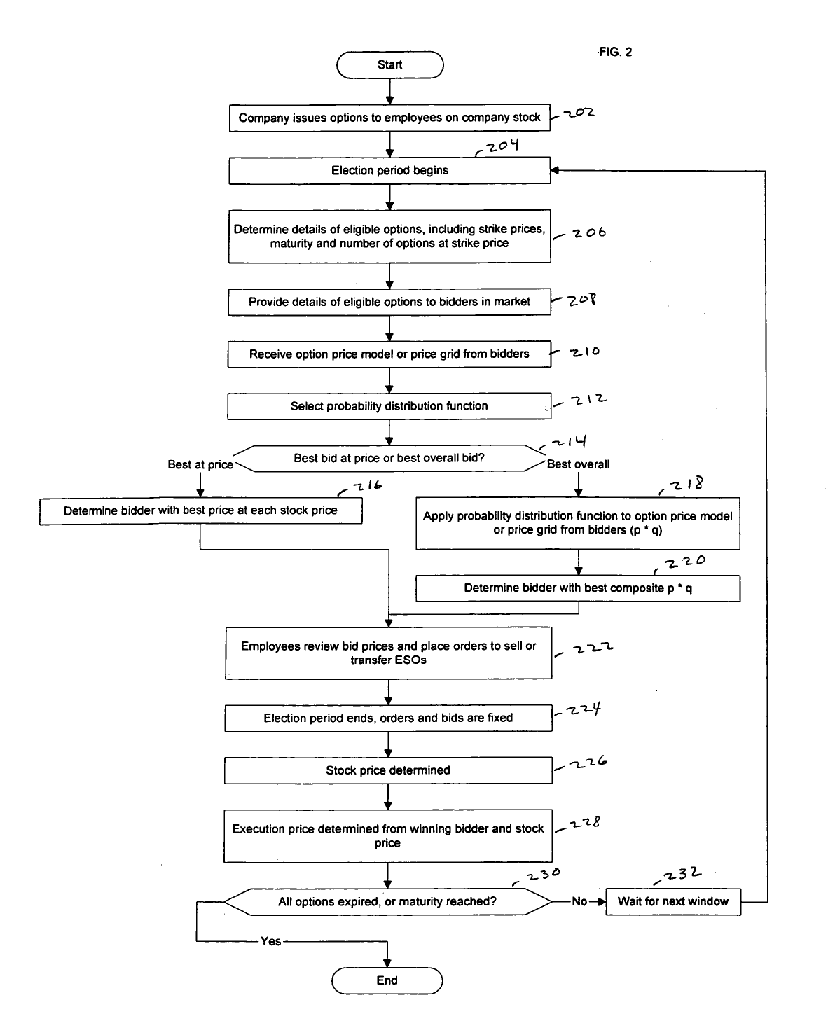

Referring to FIG. 2, at step 202, company 102 issues options on company stock (ESOs) to employees 104. In one embodiment, the ESOs have a strike price, a maturity data and a restriction on transfer.

At step 204, an election period begins. The election period may be from one day to a few months, and during the election period, the employee may elect to sell or transfer their eligible ESOs. In one embodiment, only vested ESOs are eligible for sale or transfer.

At step 206, system 100 determines details of options eligible for sale or transfer that are held by the employees. The details include the unique strike price of the options, the maturity of the options and the maximum number of options that can be sold or transferred during the period.

At step 208, system 100 provides the details of options eligible for sale or transfer to multiple eligible bidders in market 106. The multiple bidders are asked to provide fixed pricing that will be held constant over the election period and through execution.

At step 210, bidders in market 106 provide pricing information in an option pricing model or a price grid. Once the bidders provide prices, they remain fixed and locked during the election period and through execution. If any of the bidders provide a grid of option prices, it is provided for every possible or feasible stock price over the period. For example, an option price corresponding to a stock price at execution is provided for each stock price from zero to $100 when the current stock price is $50 and the period is one day. The grid may have $1 increments and an interpolation function for prices determined between the increments.

At step 212, a probability distribution function is selected, and is used to determine the preferred or winning bid(s) or bidder(s). This may occur during each election period, as illustrated in FIG. 2, or it may occur only one time before any election period.

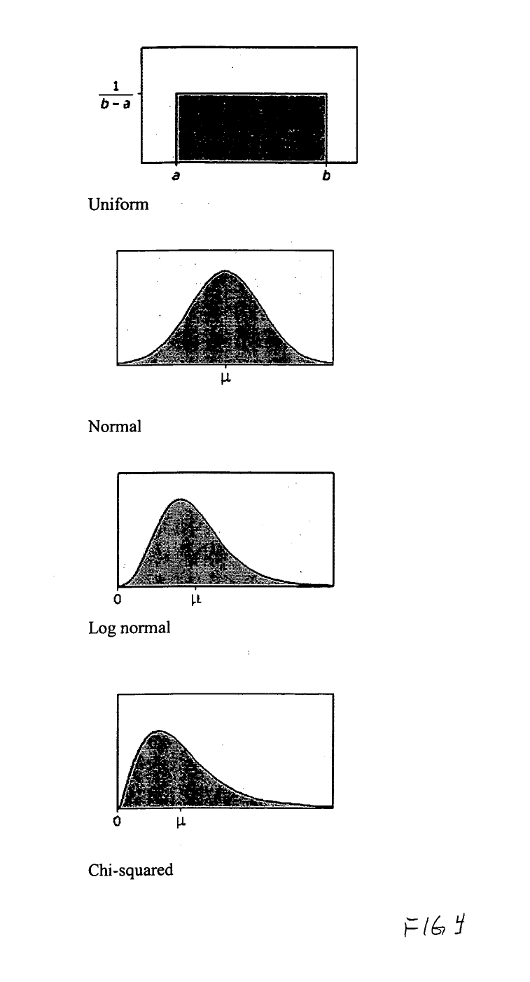

There are a number of possible probability distribution functions available for selection. Some of these distribution functions are illustrated in FIG. 4. One such probability distribution is a uniform distribution, where all the option prices are equally weighted for all possible stock prices in the grid. However, this will not take into account the likelihood that stock prices around today's level are more likely than extreme levels at either end of the grid.

Another probability distribution is the normal distribution. In a normal distribution, the distribution is symmetric on each side of the mean, and extends to infinity in each direction. Use of a uniform distribution requires an adjustment because some prices on the distribution are always less than zero. The adjustment can be an impulse at zero to take into account the concept of jump diffusion for the tail of prices below zero.

Another probability distribution is the lognormal distribution. In the lognormal distribution, there are no prices below zero, and the distribution goes to infinity on the positive side. The lognormal distribution appears to be a fairly good match of observed short term stock price fluctuations.

The Chi-squared probability distribution is another distribution that has no prices below zero and a distribution that goes to infinity on the positive side.

Finally, it is possible to create a probability distribution that is based on stock prices derived from currently traded options.

To reduce the number of option prices, system 100 may also limit the price range to a multiple of the standard deviation of the underlying distribution (e.g., one or two standard deviations above and below the current stock price).

At step 214, system 100 determines whether the preferred or winning bidder will be selected based on the best overall weighted price for the entire range of prices, or best price at a particular stock price. Although not illustrated, it is also possible that the preferred or winning bidder will be selected on the best overall weighted price for a particular class of options. For example, the class might be all options with a particular maturity and a particular strike price.

If the preferred or winning bidder is selected based on the best price at a particular stock price, then at step 216, system 100 determines the preferred bidder with the best price at each stock price.

If the preferred or winning bidder is selected based on the best overall weighted price for the entire range of prices, or the best overall weighted price for a particular class of options, then at step 218, system 100 applies the probability distribution function to the option prices provided by each bidder at step 210. The price grid or option price model that is provided by the bidder is weighted by the probability. In particular, the price is multiplied by the probability (P×Q), and a sumproduct is calculated (i.e., sum of P×Q) for each bidder.

The sumproduct represents a price density distribution, and at step 220, system 100 identifies the bidder with the best sumproduct as the preferred or winning bidder. As indicated, the bidder with the best price density distribution is the preferred or winning bidder for all options, or for all options in a particular class. This provides a preferred bidder that maximizes the expected outcome for the employee.

At step 222, system 100 provides the bid price for each option from the preferred bidder to employees 104, who can then review the bid price for their ESOs and place orders to sell or transfer their ESOs. The orders may be market or limit orders.

At step 224, the election period closes and employee orders are fixed and locked. The sale data is collected, aggregated, and number of options for each unique strike/maturity combination are reported to the applicable preferred and now winning bidder. For example, the preferred or winning bidder knows it will buy 253 options with strike of $55 and maturity of Dec. 12, 2009 and the price it will pay will be determined by reference to the stock price to be determined during the averaging period.

At step 226, which occurs shortly after the close of the election period, a reference stock price of the issuing company stock is determined during an averaging period. The reference stock price may be the closing price, volume weighted average price (VWAP) or execution pricing by the winning bidder on its hedge (sales of stock to hedge its option purchase) over the averaging period (which may be from one or part of a day to a multi-day averaging period).

At step 228, system 100 determines the execution price for each employee order from the previously identified preferred or winning bidder, associated bid price and the reference stock price determined during the averaging period. The orders are executed and execution information is then provided to employees 104 and the winning bidders in market 106.

At step 230, system 100 determines whether all options have expired or the maturity dates reached and if so, ends. If not, system 100 waits for the next election window at step 232, and then loops to step 204.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for bidding on employee stock options, the method comprising:
issuing options to an employee on stock of an issuing company at a first time, the options comprising at least a strike price, a maturity date and a vesting date;
providing information on the options to a plurality of bidders at a second time that is after the first time, the information comprising strike price, maturity date and number of options;
receiving bid information from the plurality of bidders;
selecting a probability distribution function;
computing a price density distribution for the plurality of bidders using the received bid information and the probability distribution function;
selecting a preferred bidder from the plurality of bidders based on the price density distribution; and
providing the bid information from the preferred bidder to the employee.

2. A method according to claim 1, further comprising:
receiving an order from the employee to sell or transfer at least some of the options;
executing at least part of the order; and
providing order execution information to the employee.

3. A method according to claim 2, wherein the order is a market order to sell.

4. A method according to claim 2, wherein the order is a limit order to sell.

5. A method according to claim 2, wherein the order comprises a number of options to sell.

6. A method according to claim 1, further comprising:
determining a stock price; and
determining an execution price using at least the stock price and the bid information from the preferred bidder.

7. A method according to claim 6, wherein determining a stock price; and determining an execution price occurs following the close of a predetermined election period.

8. A method according to claim 1, wherein the bid information is bid price.

9. A method according to claim 1, wherein the price density distribution is a sumproduct of price and probability.

10. A method according to claim 1, wherein the preferred bidder is the preferred bidder for all options.

11. A method according to claim 1, wherein the preferred bidder is the preferred bidder for options with a particular vesting date.

12. A method according to claim 1, wherein the preferred bidder is the preferred bidder for options with a particular strike price.

13. A method according to claim 1, wherein the preferred bidder is the preferred bidder for a particular stock price.

14. A method according to claim 1, wherein receiving bid information from the plurality of bidders further comprises receiving an option price model from at least one bidder.

15. A method according to claim 1, wherein receiving bid information from the plurality of bidders further comprises receiving a price grid from at least one bidder.

16. A method according to claim 1, wherein the preferred bidder is a winning bidder.

17. A method according to claim 1, wherein the probability distribution function is a normal distribution function.

18. A method according to claim 17, wherein the normal distribution function includes an impulse to account for prices below zero.

19. A method according to claim 1, wherein the probability distribution function is a lognormal distribution function.

20. A method according to claim 1, wherein the probability distribution function is a chi-squared distribution function.

21. A method according to claim 1, wherein providing information on the options to a plurality of bidders, receiving bid information from the plurality of bidders, computing a price density distribution for the plurality of bidders, selecting a preferred bidder from the plurality of bidders, and providing the bid information from the preferred bidder to the employee occurs during a predetermined election period.

22. A method according to claim 1, wherein the price density distribution spans an integer number of standard deviations above and below a stock price.

23. A method according to claim 22, wherein the integer number of standard deviations is one standard deviation above and below the stock price.

24. A method according to claim 22, wherein the integer number of standard deviations is two standard deviations above and below the stock price.

25. A method for bidding on employee stock options, the method comprising:
issuing options to an employee on stock of an issuing company at a first time, the options comprising at least a strike price, a maturity date and a vesting date;
providing, during an election period that is after the first time, information on the options to a plurality of bidders the information comprising strike price, maturity date and number of options;
receiving, during the election period, bid prices from the plurality of bidders wherein the bid prices are selected from the group consisting of an option price model and a price grid;
selecting a probability distribution function;
computing, during the election period, a price density distribution for the plurality of bidders using the received bid prices and the probability distribution function;
selecting, during the election period, a preferred bidder from the plurality of bidders based on the price density distribution;
providing, during the election period, the bid prices from the preferred bidder to the employee;
receiving, during the election period, a market order from the employee to sell or transfer at least some of the options;
ending the election period;
determining, during a stock price averaging period that follows the election period, a stock price;
determining an execution price using at least the stock price and the bid prices from the preferred bidder;
executing at least part of the order at the execution price; and
providing order execution information to the employee and the preferred bidder.

26. A system for bidding on employee stock options, comprising:
means for issuing options to an employee on stock of an issuing company at a first time, the options comprising at least a strike price, a maturity date and a vesting date;
means for providing information on the options to a plurality of bidders at a second time that is after the first time, the information comprising strike price, maturity date and number of options;
means for receiving bid information from the plurality of bidders;
means for selecting a probability distribution function;
means for computing a price density distribution for the plurality of bidders using the received bid information and the probability distribution function;
means for selecting a preferred bidder from the plurality of bidders based on the price density distribution; and
means for providing the bid information from the preferred bidder to the employee.

27. A computer-readable medium having computer executable software code stored thereon, the code for bidding on employee stock options, the code comprising:
code to issue options to an employee on stock of an issuing company at a first time, the options comprising at least a strike price, a maturity date and a vesting date;
code to provide information on the options to a plurality of bidders at a second time that is after the first time, the information comprising strike price, maturity date and number of options;
code to receive bid information from the plurality of bidders;
code to select a probability distribution function;
code to compute a price density distribution for the plurality of bidders using the received bid information and the probability distribution function;
code to select a preferred bidder from the plurality of bidders based on the price density distribution; and
code to provide the bid information from the preferred bidder to the employee.

28. Computer executable software code transmitted as an information signal, the code for bidding on employee stock options, the code comprising:
code to issue options to an employee on stock of an issuing company at a first time, the options comprising at least a strike price, a maturity date and a vesting date;
code to provide information on the options to a plurality of bidders at a second time that is after the first time, the information comprising strike price, maturity date and number of options;
code to receive bid information from the plurality of bidders;
code to select a probability distribution function;
code to compute a price density distribution for the plurality of bidders using the received bid information and the probability distribution function;
code to select a preferred bidder from the plurality of bidders based on the price density distribution; and
code to provide the bid information from the preferred bidder to the employee.

29. A programmed computer for bidding on employee stock options, comprising:
a memory having at least one region for storing computer executable program code; and
a processor for executing the program code stored in the memory, wherein the program code comprises:
code to issue options to an employee on stock of an issuing company at a first time, the options comprising at least a strike price, a maturity date and a vesting date;
code to provide information on the options to a plurality of bidders at a second time that is after the first time, the information comprising strike price, maturity date and number of options;
code to receive bid information from the plurality of bidders;
code to select a probability distribution function;
code to compute a price density distribution for the plurality of bidders using the received bid information and the probability distribution function;
code to select a preferred bidder from the plurality of bidders based on the price density distribution; and
code to provide the bid information from the preferred bidder to the employee.
